(19) United States
(12) Patent Application Publication
(10) Pub. No.: US 2016/0071467 A1
(43) Pub. Date: Mar. 10, 2016

(54) HAND-HELD TEST METER WITH DISPLAY ILLUMINATION ADJUSTMENT CIRCUIT BLOCK

(71) Applicant: LIFESCAN SCOTLAND LIMITED, Inverness-shire (GB)

(72) Inventors: David ELDER, Inverness (GB); Malcolm HAMER, Inverness (GB)

(21) Appl. No.: 14/783,614

(22) PCT Filed: Apr. 16, 2014
(86) PCT No.: PCT/EP2014/057812

§ 371 Date: Oct. 9, 2015

(30) Foreign Application Priority Data
Apr. 17, 2013 (GB) 1306983.6

(51) Int. Cl. G09G 3/34; G01N 27/27

(52) U.S. Cl. CPC G09G 3/3406; G01N 27/27; G09G 2360/144; G09G 2320/0626; G09G 2330/023

(57) ABSTRACT

A hand-held test meter for use with an analytical test strip in the determination of an analyte (for example, glucose)in a bodily fluid sample (such as a whole blood sample)includes a housing, a display module with a display illumination sub-module, a micro-controller disposed in the housing and a display illumination adjustment circuit block. The display illumination adjustment circuit block has a photo-sensor configured to sense ambient light levels and output a photo-sensor signal, a photo-sensor amplifier configured to receive the photo-sensor signal and output an amplified photo-sensor signal, a transfer function sub-block, and an illumination sub-module driver. The illumination sub-module driver is configured to drive the display illumination sub-module to illuminate the display module based on an illumination sub-module driver input signal.

### FIELD OF THE INVENTION

The present invention relates, in general, to medical devices and, in particular, to test meters and related methods.

### BACKGROUND OF THE INVENTION

The determination (e.g., detection and/or concentration measurement) of an analyte in, or characteristic of, a bodily fluid sample is of particular interest in the medical field. For example, it can be desirable to determine glucose, ketone bodies, cholesterol, lipoproteins, triglycerides, acetaminophen, haematocrit and/or HbAlc concentrations in a sample of a bodily fluid such as urine, blood, plasma or interstitial fluid. Such determinations can be achieved using a hand-held test meter in combination with analytical test strips (e.g., electrochemical-based analytical test strips).

### SUMMARY OF THE INVENTION

In a first aspect of the invention, there is provided a hand-held test meter for use with an analytical test strip in the determination of an analyte in a bodily fluid sample, the hand held test meter comprising: a housing; a display module that includes a display illumination sub-module; a micro-controller disposed in the housing; a display illumination adjustment circuit block with: a photo-sensor configured to sense ambient light levels and output a photo-sensor signal; a photo-sensor amplifier configured receive the photo-sensor signal and output an amplified photo-sensor signal; a transfer function sub-block; and an illumination sub-module driver configured to drive the display illumination sub-module to illuminate the display module based on an illumination sub-module driver input signal; wherein the transfer function sub-block and micro-controller are configured to apply a predetermined transfer function to convert a received amplified photo-sensor output signal into an illumination sub-module driver input signal, the illumination sub-module driver input signal compensating for a relationship between the photo-sensor signal and the user-perceived brightness of the display module.

The display module may be a Liquid Crystal Display (LCD) module and the display illumination sub-module may be a back-light Light Emitting Diode (LED) display illumination sub-module.

The photo-sensor may be a photo diode.

The predetermined transfer function may be a logarithmic transfer function.

The transfer function may be a single-stage transfer function.

The transfer function may be a multi-stage transfer function.

The multi-stage transfer function may include a logarithmic function stage and an exponential function stage.

At least the transfer function sub-block of the display illumination adjustment circuit block may be integrated with the micro-controller.

The display illumination adjustment circuit block may include a logarithmic amplifier circuit.

The illumination sub-module driver may include at least one of a digital-to-analogue converter circuit and a pulse width modulation circuit.

At least one of the micro-controller and display illumination adjustment circuit block may be configured to prevent adjusting of the display module illumination due to a transitory change in ambient light levels.

At least one of the micro-controller and display illumination adjustment circuit block may be configured to adjust the display module illumination in a ramped manner based on a sensed ambient light level.

The analytical test strip may be an electrochemical-based analytical test strip configured for the determination of glucose in a whole blood bodily fluid sample.

In a second aspect of the invention, there is provided a method for employing a handheld test meter test strip in the determination of an analyte in a bodily fluid sample, the method comprising: employing a photo-sensor of a display illumination adjustment circuit block of the hand-held test meter to sense ambient light levels and output a photo-sensor signal related to the sensed ambient light level; amplifying the photo-sensor signal into an amplified photo-sensor signal using a photo-sensor amplifier of the display illumination adjustment circuit block; applying a predetermined transfer function to convert the amplified photo-sensor output signal into an illumination sub-module driver input signal using a transfer function sub-block of the display illumination adjustment circuit block, the illumination sub-module driver input signal compensating for a relationship between the photo-sensor signal and user-perceived brightness of a display module of the hand-held test meter; and adjusting user-perceived brightness of the display module using the illumination sub-module driver input signal and an illumination sub-module driver of the display illumination adjustment circuit block.

The method may further include: inserting an analytical test strip into the hand-held test meter; and determining at least one of an analyte in a bodily fluid sample applied to the analytical test strip using a micro-controller of the hand-held test meter.

The analyte test strip may be configured for determination of glucose in a whole blood sample.

The display module may be a Liquid Crystal Display (LCD) module and the display illumination sub-module may be a back-light Light Emitting Diode (LED) display illumination sub-module.

The photo-sensor may be a photodiode.

The predetermined transfer function may be a logarithmic transfer function.

The predetermined transfer function may be a single-stage transfer function.

The predetermined transfer function may be a multi-stage transfer function.

The multi stage transfer function may include a logarithmic function stage and an exponential function stage.

Adjusting the display of the module illumination due a transitory change in ambient light levels may be prevented.

Adjusting of the display module illumination may occur in a ramped manner.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, in which like numerals indicate like elements, of which:

FIG. 1 is a simplified perspective depiction of a hand-held test meter according to an embodiment of the present invention;

FIG. 2 is a simplified perspective view of the hand-held test meter of FIG. 1;

FIG. 3 is a simplified top view of the hand-held test meter of FIG. 1;

FIG. 4 is a simplified block diagram of various blocks of the hand-held test meter of FIG. 1;

FIG. 5 is a simplified schematic and block diagram of a display illumination adjustment circuit block partially integrated with a micro-controller and a display illumination Light Emitting Diode (LED) as can be employed in embodiments of the present invention;

FIG. 6 is a simplified schematic diagram of a display illumination adjustment circuit block as can be employed in embodiments of the present invention;

FIG. 7 is an electrical schematic of commercially available integrated photo-diode and amplifier as can be employed in a display illumination adjustment circuit block included in embodiments of the present invention;

FIG. 8 is a simplified combination graph of ambient light versus time (in the upper portion of the graph) and the corresponding display illumination versus time as can be obtained from a hand-held test meter according to an embodiment of the present invention; and

FIG. 9 is a flow diagram depicting stages in a method for employing a hand-held test meter according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

In general, hand-held test meters for use with an analytical test strip in the determination of an analyte (for example, glucose) in a bodily fluid sample (such as a whole blood sample)according to embodiments of the present invention include a housing, a display module with a display illumination sub-module, a micro-controller and a display illumination adjustment circuit block. The display illumination adjustment circuit block has a photo-sensor configured to sense ambient light levels and output a related photo-sensor signal, a photo-sensor amplifier configured to receive the photo-sensor signal and output an amplified photo-sensor signal, a transfer function sub-block, and an illumination sub-module driver. The illumination sub-module driver is configured to drive the display illumination sub-module to illuminate the display module based on an illumination sub-module driver input signal. In addition, the transfer function sub-block and micro-controller are configured to apply a predetermined transfer function (such as a logarithmic transfer function or a suitable multi-stage transfer function) to convert a received amplified photo-sensor output signal into an illumination sub-module driver input signal, the illumination sub-module driver input signal compensating for a relationship (e.g., a logarithmic relationship) between the photo-sensor signal and user-perceived brightness of the display module.

Hand-held test meters according to embodiments of the present invention are beneficial in that the display illumination adjustment circuit block is configured to automatically adjust the user-perceived brightness of the hand-held test meter's display module to compensate for ambient light levels. For example, in a high ambient light scenario the illumination of the display module will be increased, while in a low ambient light scenario the illumination of the display module will be decreased, thereby making the display module easily and comfortably read by a user in both high and low ambient light. In addition, the ability to discreetly use the hand-held test meter in low ambient light is beneficially enhanced by avoiding over illumination of the display module that can attract the unwanted attention of those nearby. Moreover, automatically decreasing the illumination of the display module in low ambient light scenarios can beneficially conserve power and eliminate the need for manually operated low illumination buttons or display menu-based options.

Once one skilled in the art is apprised of the present disclosure, he or she will recognize that an example of a hand-held test meter that can be readily modified as a hand-hand test meter according to the present invention is the commercially available OneTouch® Ultra® 2 glucose meter from LifeScan Inc. (Milpitas, Calif.). Additional examples of hand-held test meters that can also be modified are found in U.S. Patent Application Publications No's. 2007/0084734 (published on Apr. 19, 2007) and 2007/0087397 (published on Apr. 19, 2007) and in International Publication Number WO2010/049669 (published on May 6, 2010), each of which is hereby incorporated herein in full by reference.

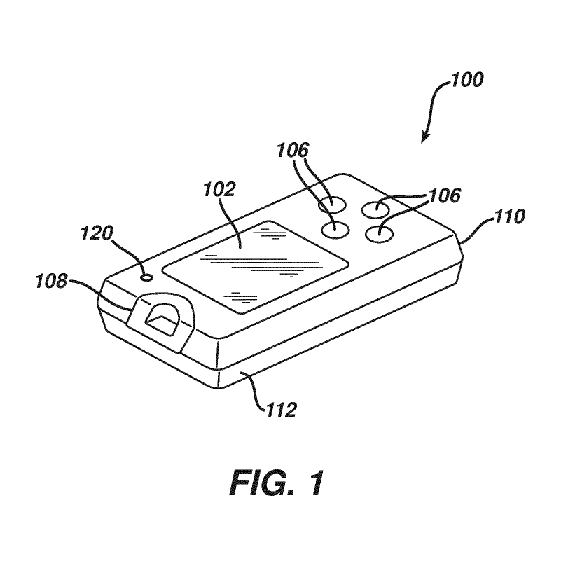

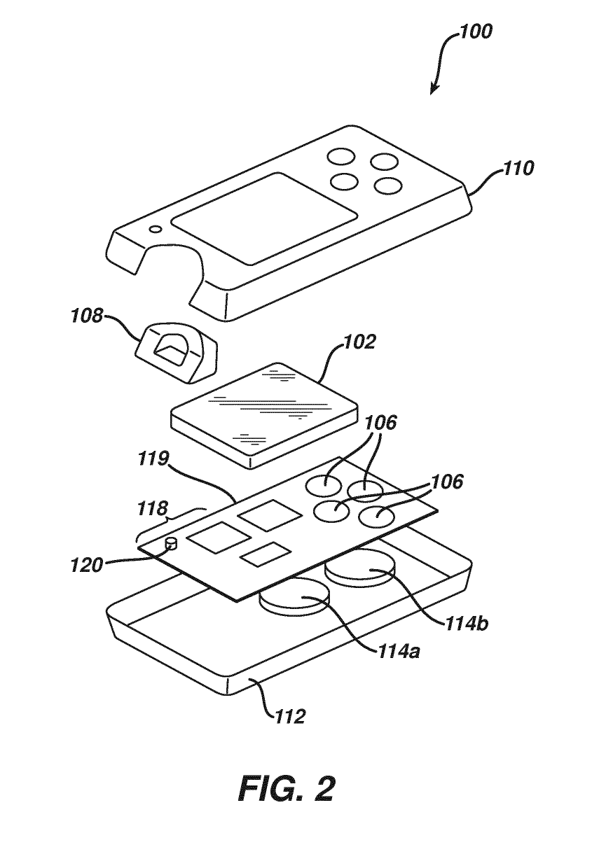

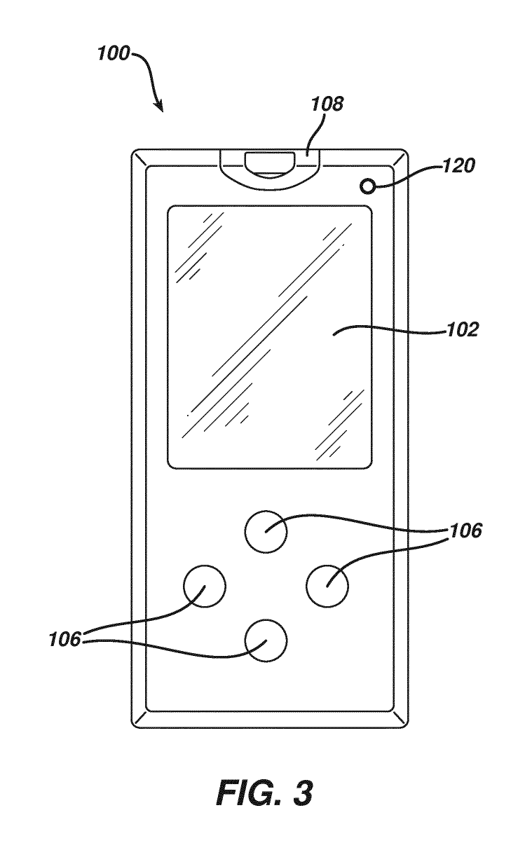

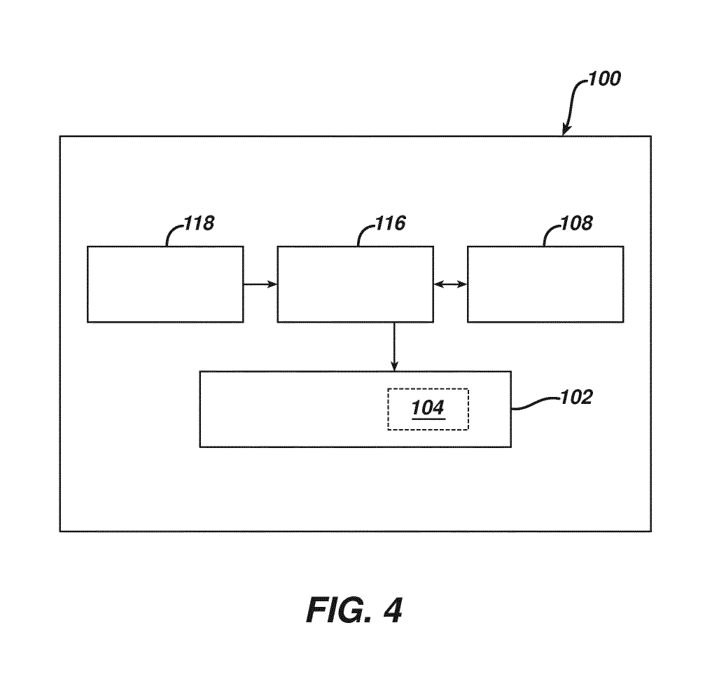

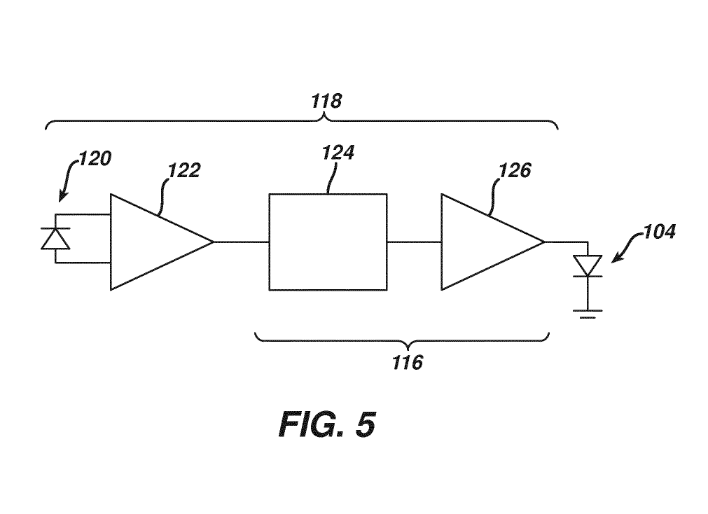

FIG. 1 is a simplified perspective depiction of a hand-held test meter 100 according to an embodiment of the present invention. FIG. 2 is a simplified perspective exploded view of the hand-held test meter 100. FIG. 3 is a simplified top view of the hand-held test meter 100. FIG. 4 is a simplified block diagram of various blocks of the hand-held test meter 100. FIG. 5 is a simplified schematic and block diagram of a display illumination adjustment circuit block, micro-controller and display illumination Light Emitting Diode (LED) as can be employed in embodiments of the present invention including hand-held test meter 100.

Referring to FIGS. 1 and 5, hand-held test meter 100 includes a display module 102 that includes a display illumination sub-module 104 (depicted in FIGS. 4 and 5 with the FIG. 5 depiction represented as a backlight Light Emitting Diode (LED)), a plurality of user interface buttons 106, a strip port connector 108, an upper housing portion 110, a lower housing portion 112 and batteries 114a and 114b. Upper and lower housing portions 110 and 112 are referred to collectively as a “housing.” Hand-held test meter 100 also includes a micro-controller 116, a display illumination circuit block 118, and other electronic components (not shown) for applying an electrical bias (e.g., an alternating current (AC) and/or direct current (DC) bias) to an electrochemical-based analytical test strip and also for measuring an electrochemical response (e.g., plurality of test current values) and determining an analyte or characteristic based on the electrochemical response. To simplify the current descriptions, the figures do not depict all such electronic circuitry. Micro-controller 116 and display illumination circuit block 118 are mounted on printed circuit board (PCB) 119.

Display illumination circuit block 118 includes a photo-sensor 120 (depicted as a photo-diode in FIG. 5) configured to sense ambient light levels and output a photo-sensor signal, a photo-sensor amplifier 122 configured to receive the photo-sensor signal and output an amplified photo-sensor signal, a transfer function sub-block 124, and an illumination sub-module driver 126 configured to drive the display illumination sub-module to illuminate the display module based on an illumination sub-module driver input signal (see FIG. 5 in particular). In the embodiment depicted in FIG. 5, transfer function sub-block 124 and illumination sub-module 126 are integrated into micro-controller 116. In such an embodiment, micro-controller 116 can contain a transfer function algorithm(s) within the micro-controller's memory or contain a transfer function look-up table in the micro-controller's memory. Once apprised of the present disclosure, one skilled in the art will recognize that the extent of integration of a display illumination circuit block into a micro-controller can vary from that depicted in simplified FIG. 5. For example, functions of an illumination sub-module driver can be split between integration into a micro-controller and an independent amplifier and/or predetermined functions of a photo-sensor amplifier 122 can be integrated into the micro-controller. Such integration can, for example, optimally employ typical analog-to-digital (ADC) and digital-to-analog (DAC) functionality of a micro-controller while also employing micro-controller transfer function capabilities.

In hand-held test meter 100, the transfer function sub-block and micro-controller are configured to apply a predetermined transfer function (such as a logarithmic transfer function) to convert a received amplified photo-sensor output signal into an illumination sub-module driver input signal, the illumination sub-module driver input signal compensating for a relationship between the photo-sensor signal and user-perceived brightness of the display module.

Display Module 102 can be, for example, any suitable Liquid Crystal Display (LCD) configured to show a screen image. An example of a screen image during the determination of an analyte in a bodily fluid sample may include a glucose concentration, a date and time, an error message, and a user interface for instructing a user how to perform a test.

Display illumination sub-module 104 can be, for example, a back-light Light Emitting Diode (LED) display illumination sub-module (as depicted in FIG. 5) or any other suitable display illumination sub-module known to one of skill in the art.

Strip port connector 108 is configured to operatively interface with an electrochemical-based analytical test strip, such as an electrochemical-based analytical test strip configured for the determination of hematocrit and/or glucose in a whole blood sample. Therefore, the electrochemical-based analytical test strip is configured for operative insertion into strip port connector 108 and to operatively interface with micro-controller 116 via, for example, suitable electrical contacts, wires, electrical interconnects or other structures known to one skilled in the art.

Micro-controller 116 is disposed within the housing (i.e., within the assembled upper and lower housing portions 110 and 112) and can include any suitable micro-controller and/or micro-processor known to those of skill in the art. Suitable micro-controllers include, but are not limited to, micro-controllers available commercially from Texas Instruments (Dallas, Tex., USA) under the MSP430 series of part numbers; from ST MicroElectronics (Geneva, Switzerland) under the STM32F and STM32L series of part numbers; and Atmel Corporation (San Jose, Calif., USA) under the SAM4L series of part numbers). Micro-controller 116 can, for example, be configured to receive an amplified photo-sensor signal continuously, whilst the hand-held meter is on, and apply a predetermined transfer function (e.g., a logarithmic function). Micro-controller 116 is also configured to employ the display module to indicate, for example, blood glucose concentration and other user interface information.

Photo-sensor 120 can be any suitable photo-sensor such as, for example, a photo-diode. One such photo-sensor is commercially available from Intersil (Milpitas, Calif., USA) as part number ISL29102. Typically, the photo-sensor will be disposed on the front face of the housing (see, for example, FIG. 1) such that the photo-sensor detects the ambient light falling on the display module without interference from the display module illumination generated by the hand-held meter itself.

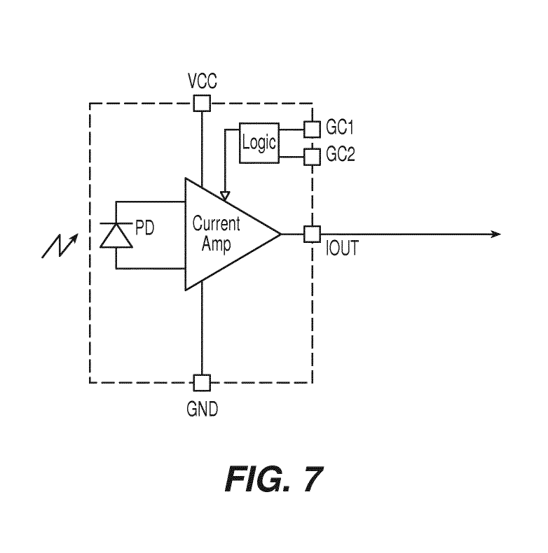

Photo-sensor amplifier 122 can be any suitable photo-sensor amplifier known to one of skill in the art. If desired, the photo-sensor amplifier can be integrated with the photo-sensor as described with respect to FIG. 7.

Transfer function sub-block 124 can take any suitable form and, if desired, be integrated into micro-controller 116. Moreover, transfer function sub-block 124 can be implemented in hardware, software or a combination thereof.

The transfer function is predetermined such that the display module brightness as perceived by a user is essentially constant regardless of the ambient light levels. In this regard, it is noted that the perception of light by the human eye is called “Luminous Intensity”, measured in candela, and for a display module, the term brightness should be referred to as luminance and is measured in candela/square-meter. A typical pulse width modulation (PWM) produces a linear relationship between electrical input and optical power. Moreover, the human eye response for optical power is essentially logarithmic. Therefore, a useful, but non-limiting transfer function of input power to perceived brightness would be a single-stage logarithmic function. A typical silicon photodiode response is linear with radiant light power (radiometric response). The transfer function can, therefore, be logarithmic to give the correct perception of brightness to a user. Such logarithmic function can be performed in hardware, but can also be performed in software within the micro-controller and/or a memory block of the hand-held test meter. The transfer function can, for example, be performed mathematically (e.g., by using a logarithmic function) or through the use of a look-up table.

In addition to single-stage logarithmic transfer function, it can also be beneficial to employ a multi-stage transfer function. An exemplary, but non-limiting, three-stage transfer function can include the following three sequential stages. A first stage that employs a logarithmic function to convert a photodiode output (e.g., an amplified photo-sensor signal) into a value corresponding to user perceived brightness of the ambient light. A second stage that adjusts (i.e., compensates) the user-perceived brightness of a display module based on the value from the first stage by applying an adjusting gradient and/or offset and a third stage that transfers the result of the second stage back to an illumination sub-module driver input in the linear domain using an exponential conversion algorithm.

Illumination sub-module driver 126 can be any suitable illumination sub-module driver including, for example, a PWM based illumination sub-module driver or a digital-to-analog converter (DAC) circuit based illumination sub-module driver.

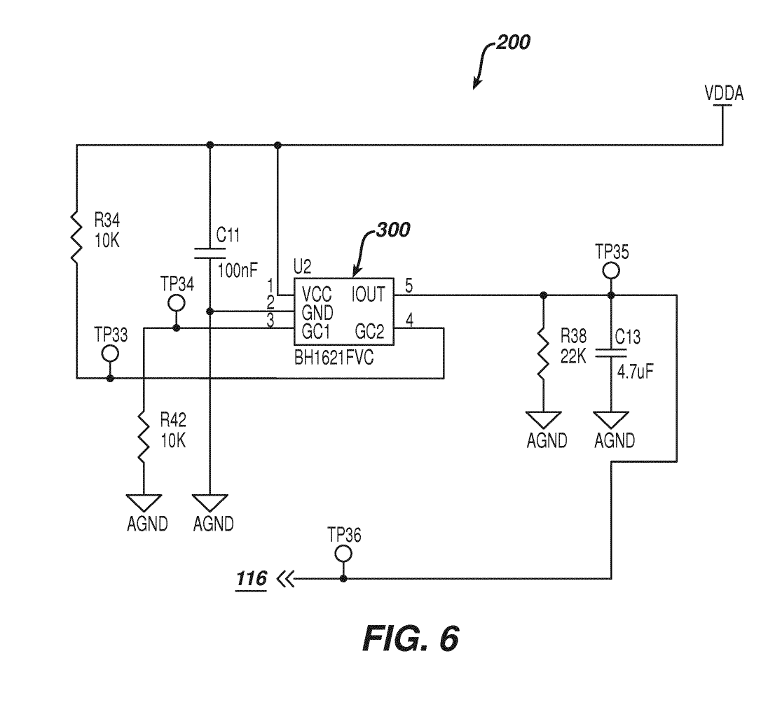

FIG. 6 is a simplified schematic diagram of a display illumination adjustment circuit block 200 as can be employed in embodiments of the present invention. FIG. 7 is an electrical schematic of commercially available integrated photo-diode and amplifier 300 as can be employed in a display illumination adjustment circuit block 200.

Referring to FIGS. 6 and 7, display illumination adjustment circuit block 200 includes a photo-sensor and photo-sensor amplifier integrated into a single component 300. Component (also referred to as “integrated photo-diode and amplifier”) 300 can be, for example, a device commercially available from Rohm as part number BH1621FVC that combines a photo-sensor and an amplifier (see FIG. 7 in particular). This commercially available device has a similar spectral response to the human eye, i.e. is more sensitive to greens and less to blues and reds.

Resistor R38 and capacitor C13 of display illumination circuit block 200 are configured to provide a filtering response to stop the display brightness from flickering unnecessarily. Resistors R34 and R42 of display illumination circuit block 200 are configured to provide again setting for the built in amplifier of component 300. Capacitor C11 is configured as a noise-reducing power supply decoupling capacitor. TP33, TP34 and TP235 are test connection points.

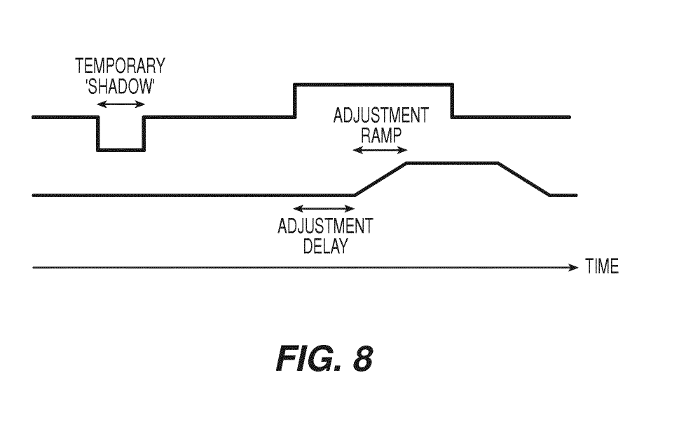

FIG. 8 is a simplified combination graph of ambient light versus time (in the upper portion of the graph) and the corresponding display illumination versus time (in the lower portion of the graph)as can be obtained from a hand-held test meter according to an embodiment of the present invention.

Hand-held test meters according to embodiments of the present invention can, if desired, be configured such that (i) the display module illumination is not adjusted due to a transitory and/or intermittent changes in ambient light levels that have a duration, for example, of less than 3 seconds or less than 10 seconds, and (ii) the display illumination is adjusted in a gradual (i.e., ramped) manner to achieve a desired level of illumination and not in an abrupt set-wise manner. Avoiding adjustments due to transitory and/or intermittent changes in ambient light levels can be achieved, for example, by introducing a time-delay in the response of the display illumination adjustment circuit block and/or micro-controller. Such a delay can be achieved using any suitable hardware-based and/or suitable software-based methodologies. FIG. 8 depicts both the response to a transitory change in ambient light and a ramped change in display module illumination in response to a non-transitory change in ambient light. The rate of ramped change in display module illumination can be, for example, a rate equivalent to ramping the display module illumination from minimum brightness to maximum brightness in the range of 1 second to 10 seconds.

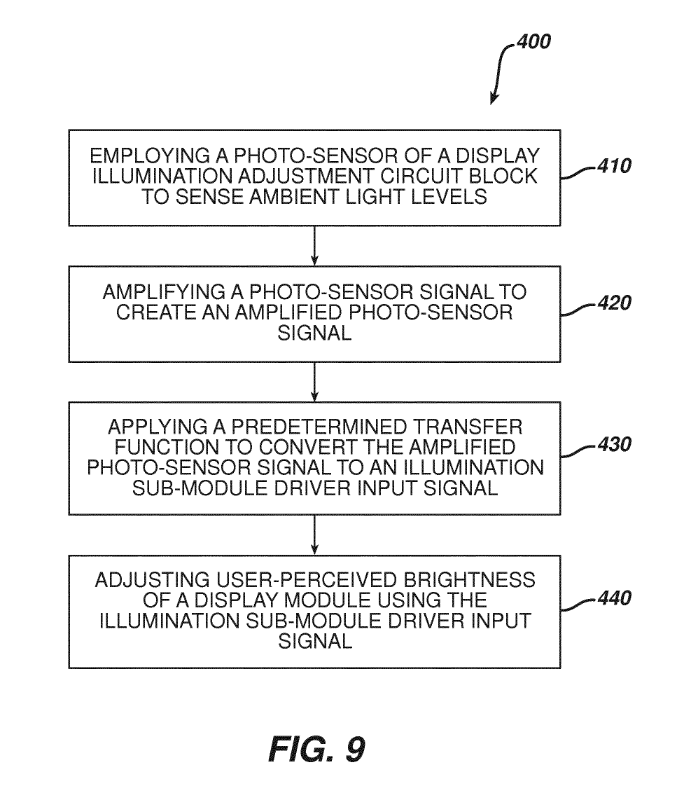

FIG. 9 is a flow diagram depicting stages in a method 400 for employing a hand-held test meter (e.g., hand-held test meter 100 of FIG. 1) for use with an analytical test strip (such as an electrochemical-based analytical test strip) for the determination of an analyte (for example glucose) in a bodily fluid sample (e.g., a whole blood sample), according to an embodiment of the present invention. Method 400 includes employing a photo-sensor of a display illumination adjustment circuit block of the hand-held test meter to sense ambient light levels and to output a photo-sensor signal related to the sensed ambient light level (see step 410 of FIG. 9).

At step 420, the photo-sensor signal is amplified into an amplified photo-sensor signal using a photo-sensor amplifier of the display illumination adjustment circuit block. A predetermined transfer function (such as a logarithmic transfer function)is applied in step 430 to convert the amplified photo-sensor output signal into an illumination sub-module driver input signal using a transfer function sub-block of the display illumination adjustment circuit block. It should be noted that the illumination sub-module driver input signal compensates for a relationship between the photo-sensor signal and user-perceived brightness of a display module of the hand-held test meter. A typical simplified, but non-limiting, example of a logarithmic transfer function is represented by the following equation:

y=a log(bx)+c

where

x=an amplified photo-sensor signal;

y=illumination sub-module driver input signal; and
a, band c=experimentally and/or theoretically derived constants.
   Once apprised of the present disclosure, one of skill in the art can readily devise other single stage or multi-stage transfer functions.

At step 440, user-perceived brightness of a display module of the hand-held test meter is adjusted using the illumination sub-module driver input signal and an illumination sub-module driver of the display illumination adjustment circuit block.

As desired, method 400 can further include inserting an analytical test strip into the hand-held test meter and determining at least one of an analyte in a bodily fluid sample applied to the analytical test strip using a micro-controller of the hand-held test meter.

Once apprised of the present disclosure, one skilled in the art will recognize that methods according to embodiments of the present invention, including method 400, can be readily modified to incorporate any of the techniques, benefits and characteristics of hand-held test meters according to embodiments of the present invention and described herein.

Once apprised of the present disclosure, one skilled in the art will recognize that the meters and methods according to embodiments of the present invention, including method 400, can employ any suitable electrochemical techniques, including those based on Cottrell current measurements, coulometry, amperometry, chronoamperometry, potentiometry, and chronopotentiometry.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

1.-24. (canceled)

25. A hand-held test meter for use with an analytical test strip in the determination of an analyte in a bodily fluid sample, the hand-held test meter comprising:
a housing;
a display module that includes:
a display illumination sub-module;
a micro-controller disposed in the housing;
a display illumination adjustment circuit block with:
a photo-sensor configured to sense ambient light levels and output a photo-sensor signal;
a photo-sensor amplifier configured to receive the photo-sensor signal and output an amplified photo-sensor signal;
a transfer function sub-block; and
an illumination sub-module driver configured to drive the display illumination sub-module to illuminate the display module based on an illumination sub-module driver input signal;
wherein the transfer function sub-block and micro-controller are configured to apply a predetermined transfer function to convert a received amplified photo-sensor output signal into an illumination sub-module driver input signal, the illumination sub-module driver input signal compensating for a relationship between the photo-sensor signal and user-perceived brightness of the display module.

26. The hand-held test meter of claim 25 wherein the display module is a Liquid Crystal Display (LCD) module and the display illumination sub-module is a back-light Light Emitting Diode (LED) display illumination sub-module.

27. The hand-held test meter of claim 25 wherein the photo-sensor is a photodiode.

28. The hand-held test meter of claim 25 wherein the predetermined transfer function is a logarithmic transfer function.

29. The hand-held test meter of claim 25 wherein the transfer function is a single-stage transfer function.

30. The hand-held test meter of claim 25 wherein the transfer function is a multi-stage stage function.

31. The hand-held test meter of claim 30 wherein the multi-stage transfer function includes a logarithmic function stage and an exponential function stage.

32. The hand-held test meter of claim 25 wherein at least the transfer function sub-block of the display illumination adjustment circuit block is integrated with the micro-controller.

33. The hand-held test meter of claim 25 wherein the display illumination adjustment circuit block includes a logarithmic amplifier circuit.

34. The hand-held test meter of claim 25 wherein the illumination sub-module driver includes at least one of a digital-to-analog converter circuit and a pulse width modulation circuit.

35. The hand-held test meter of claim 25 wherein at least one of the micro-controller and display illumination adjustment circuit block are configured to prevent adjusting of the display module illumination due to a transitory change in ambient light levels.

36. The hand-held test meter of claim 25 wherein at least one of the micro-controller and display illumination adjustment circuit block are configured to adjusting the display module illumination in a ramped manner based on a sensed ambient light level.

37. The hand-held test meter of claim 25 wherein the analytical test strip is an electrochemical-based analytical test strip configured for the determination of glucose in a whole blood bodily fluid sample.

38. A method for employing a hand-held test meter for use with an analytical test strip in the determination of an analyte in a bodily fluid sample, the method comprising:
employing a photo-sensor of a display illumination adjustment circuit block of the hand-held test meter to sense ambient light levels and output a photo-sensor signal related to the sensed ambient light level;
amplifying the photo-sensor signal into an amplified photo-sensor signal using a photo-sensor amplifier of the display illumination adjustment circuit block;
applying a predetermined transfer function to convert the amplified photo-sensor output signal into an illumination sub-module driver input signal using a transfer function sub-block of the display illumination adjustment circuit block, the illumination sub-module driver input signal compensating for a relationship between the photo-sensor signal and user-perceived brightness of a display module of the hand-held test meter; and
adjusting user-perceived brightness of the display module using the illumination sub-module driver input signal and an illumination sub-module driver of the display illumination adjustment circuit block.

39. The method of claim 38 further including:
inserting an analytical test strip into the hand-held test meter; and
determining at least one of an analyte in a bodily fluid sample applied to the analytical test strip using a micro-controller of the hand-held test meter.

40. The method of claim 39 wherein the analytical test strip is configured for the determination of glucose in a whole blood sample.

41. The method of claim 38 wherein the display module is a Liquid Crystal Display (LCD) module and the display illumination sub-module is a back-light Light Emitting Diode (LED) display illumination sub-module.

42. The method of claim 38 wherein the photo-sensor is a photodiode.

43. The method of claim 38 wherein the predetermined transfer function is a logarithmic transfer function.

44. The method of claim 38 wherein the predetermined transfer function is a single-stage transfer function.
